(19) United States
(12) Patent Application Publication
(10) Pub. No.: US 2019/0306730 A1
(43) Pub. Date: Oct. 3, 2019

(54) DATA SOURCE SIMULATION PLATFORM

(71) Applicant: Chongqing University of Posts and Telecommunications, Chongqing (CN)

(72) Inventors: Zhizhong ZHANG, Chongqing (CN); Hanzhong HUANG, Chongqing (CN); Song XIE, Chongqing (CN); Xiaoling HU, Chongqing (CN); Linlin FENG, Chongqing (CN); Lilan LIU, Chongqing (CN); Lei ZHU, Chongqing (CN)

(21) Appl. No.: 16/371,103

(22) Filed: Mar. 31, 2019

(30) Foreign Application Priority Data
Mar. 30, 2018 (CN) 201810289183.1

(51) Int. Cl. H04W 24/06; H04L 29/06; H04L 5/00; H04W 56/00; H04W 72/08; H04L 1/24; H04L 1/00

(52) U.S. Cl. CPC H04W 24/06; H04L 67/38; H04L 5/0048; H04L 1/0013; H04W 56/001; H04W 72/085; H04L 1/242; H04L 5/0055

(57) ABSTRACT

A data source simulation platform includes: a transmitting side and a receiving side. The transmitting side includes a parameter initializing module, a parameter calculation module, and a subframe data module. The receiving side includes a system function configuration module, a downlink initial synchronization module, an error control module, a time-frequency estimation module, and a data parsing module. The parameter initializing module is configured to construct simulation parameters, configure a subframe structure, and simulate a raw data block to be transmitted from a protocol data unit packet of a media access control layer to a physical layer. The parameter calculation module is configured to calculate set simulation parameters. The subframe data module is configured to provide independent data for an air-interface monitoring device, the data being in a modular design and independently corresponding to each submodule.

### CROSS-REFERENCE TO RELATED APPLICATIONS

Pursuant to 35 U.S.C. § 119 and the Paris Convention Treaty, this application claims foreign priority to Chinese Patent Application No. 201810289183,1 filed Mar. 30, 2018, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of wireless communication, and more particularly to a data source simulation platform based on a long term evolution (LTE) physical layer protocol.

Conventional simulation technologies for communication systems include circuit test and manual analysis. The methods are complex and time-consuming.

### SUMMARY

The disclosure provides an LTE-advanced (LTE-A) based data source simulation platform that can efficiently simulate and analyze the technical performance index of physical lasers.

Disclosed is an LTE-A based data source simulation platform. The submodules required by the data source simulation platform are determined according to the LTE-A downlink transmission process; the information such as subframe synchronization, cyclic prefix (CP) type, and cell ID are acquired according to a terminal synchronization process using primary synchronization signals/secondary synchronization signals (PSS/SSS); then, system bandwidth, frame number, and physical hybrid ARQ indicator channel (PHICH) related resource configuration are obtained by receiving a physical broadcasting channel (PBCH). The uplink and downlink configuration parameters are included in the system messages. Therefore, PHICH channel resource group number is unknown before the system messages are correctly decoded. Because the system information is included in a physical downlink shared channel (PDSCH), and the control information required for PDSCH channel decoding is all included in the physical downlink control channel (PDCCH), the PDCCH channel must be decoded. It can be known from the entire procedure that, from cell search, acquiring system information, random access, to establishing a connection for data. transmission, the data submodules required by each subframe comprises such signaling contents as a synchronization signal, a reference signal, five kinds of physical channels, and downlink control information (DCI).

In the platform, a transmitter simulates a process from a raw data block through a series of processing to a baseband transmission signal generation, thus accomplishing an LTE-A based data source simulation; the data source simulation platform comprises: a transmitting side and a receiving side. The transmitting side comprises a parameter initializing module, a parameter calculation module, and a subframe data module. The receiving side comprises a system function configuration module, a downlink initial synchronization module, an error control module, a time-frequency estimation module, and a data parsing module.

The parameter initializing module is configured to construct simulation parameters, configure a subframe structure, and simulate a raw data block to be transmitted from a protocol data unit (PDU) packet of a media access control (MAC) layer to a physical layer.

The parameter calculation module is configured to calculate set simulation parameters, and is mainly for configuration of resource block; the LTE physical layer is defined based on resource blocks in a bandwidth-agnostic manner, thus allowing the LTE physical layer to adapt to different spectrum allocations; different bandwidths correspond to different amount of allocation; each resource block is a resource block which contains time-domain resources occupied by one slot in time, and contains resources occupied by 12 sub-carriers in frequency; the subframe data module is used to provide independent data required by an air-interface monitoring device.

The subframe data module is configured to provide independent data for an air-interface monitoring device, the data being in a modular design and independently corresponding to each submodule.

The system function configuration module is configured to change a target data source for data comparison in a test phase.

The downlink initial synchronization module is configured to detect a downlink synchronization signal, the detection comprising frequency domain overlapping detection of a main synchronization signal and incoherent detection of an auxiliary synchronization signal.

The error control module is configured to add errors to a data and verify a corresponding algorithm.

The time-frequency estimation module is configured to estimate and correct a normalized time-frequency deviation before receiving demodulation data by fast Fourier transformation (FFT) and complete the synchronous tracking of input data before data parsing.

The data parsing module is configured to parse the information carried by each channel and complete the processing opposite to channel links.

The subframe data module comprises:

a synchronization signal module being configured for cell intra-group detection, symbol timing alignment, frequency synchronization and cell group detection, frame timing alignment, and CP length detection;

a reference signal module being configured for downlink channel quality measurement and downlink channel estimation, coherent detection and demodulation at a UE end; the reference signal comprising a cell-specific reference signal, a UE-specific reference signal, and a channel state indication reference signal;

a downlink control information module is configured to enable a terminal to correctly decode DCI information to process PDSCH data or PUSCH data; the downlink control information comprising resource block allocation information, modulation scheme modulation and coding scheme (MCS), hybrid automatic repeat request-identity (HARQ-ID);

a channel generation module; and

a channel link module.

The channel generation module comprises:

a physical downlink broadcast channel module is configured to carry broadcast information and transmit parameters comprising system bandwidth and frame number in a cell;

a physical downlink control channel (PDCCH) module is configured to indicate the number of orthogonal frequency division multiplexing (OFDM) symbols used for transmitting PDCCH in one subframe, to notify a UE about the size of a control region corresponding to a downlink subframe, that is, the number of OFDM symbols occupied by the control region;

a physical downlink control channel module is configured to carry scheduling and other control information; in the platform, the module mainly performs signal procedure processing on downlink control information;

a physical downlink shared channel module is configured to transmit service data, and is a downlink channel that carries primary user data in LTE, and includes a system broadcast message and a paging message that are not transmitted in PBCH; and

a physical downlink hybrid automatic retransmission indication channel module is configured to respond an ACK/NACK indication for data transmitted by an uplink shared channel. Each uplink transmission block in each subframe corresponds to one PHICH, that is, when a UE is configured with uplink space division multiplexing in a certain cell, two PHICHs are required.

The channel link module comprises:

a cyclic redundancy check calculation module is configured for error detection; so that a receiving end does not need to provide correction conditions for each bit, which can effectively reduce hardware cost when the number of bits increases;

a code block segmentation module is configured to adapt to data size for channel coding;

a cyclic redundancy check secondary addition module is configured to reduce retransmission delay for hybrid automatic repeat request at a receiving end, and save processing time; thus avoiding power consumption of subsequent subcode block decoding;

a channel coding module is configured to change degree of redundancy of transmitted information to adapt to actual physical layer capability;
a rate matching module is configured to select a bit stream formed by the channel coding module, to form a different coding rate and match a physical resource that is actually used;
a code block cascading module is configured to connect rate-matched outputs of all code blocks, thus constituting a codeword of a length;
a scrambling module is configured to achieve randomization of data interference, to reduce neighboring-cell interference to some extent;
a modulation module is configured to convert various digital baseband signals into modulated signals suitable for channel transmission;
a multiple-input multiple-output (MIMO) processing module is configured to improve capacity and reliability of channels, and reduce bit error rate at the link level;
a resource mapping module is configured to sequentially map data signals to corresponding resource elements of a subframe according to a certain rule; and
an orthogonal frequency division multiplexing (OFDM) modulation module is configured to generate a complex time-domain OFDM signal for each antenna port.

In the technical solution, the platform initializing module is configured to simulate a raw data block to be transmitted from a protocol data, unit (PDU) packet of a media access control (MAC) layer to a physical layer. The simulation parameter represents all transmission information of the base station side, and parameter calculation and mode configuration are respectively performed to generate data required by an air-interface monitoring device during a testing phase in a format that supports all protocols. The transmission system mainly includes submodules for such as source generation, data mapping, multi-antenna processing and data framing, etc., to process link-level data. As for channels, channel generation and data loading are included. The transmission system and channels are combined to accomplish the link simulation of the data source simulation platform. Upon simulating the generation of data of the transmitting end, based on the key technologies of LTE physical layer downlink, the LTE physical layer downlink is modularly designed, to study and evaluate relevant data of an LTE physical layer decoding end, decode and verify the encoding data, establish a complete LTE-A air-interface monitoring analyzer simulation platform, and obtain performance comparison analysis.

### BRIEF DESCRIPTION OF THE DRAWINGS

FIGS. 1A-1F are a signal processing flowchart of an LTE-A based data source simulation platform according to the disclosure;

FIG. 2 is a flowchart showing development of an LTE-A based data source simulation platform of the disclosure;

FIG. 3 is a data abstract model of an LTE-A based data source simulation platform of the disclosure;

FIG. 4 is an operation interface diagram of an LTE-A based data source simulation platform of the disclosure; and

FIG. 5 is a module blueprint of an LTE-A based data source simulation platform of the disclosure.

### DETAILED DESCRIPTION

To further illustrate, embodiments detailing an LTE-A-based data source simulation platform are described below. It should be noted that the following embodiments are intended to describe and not to limit the disclosure.

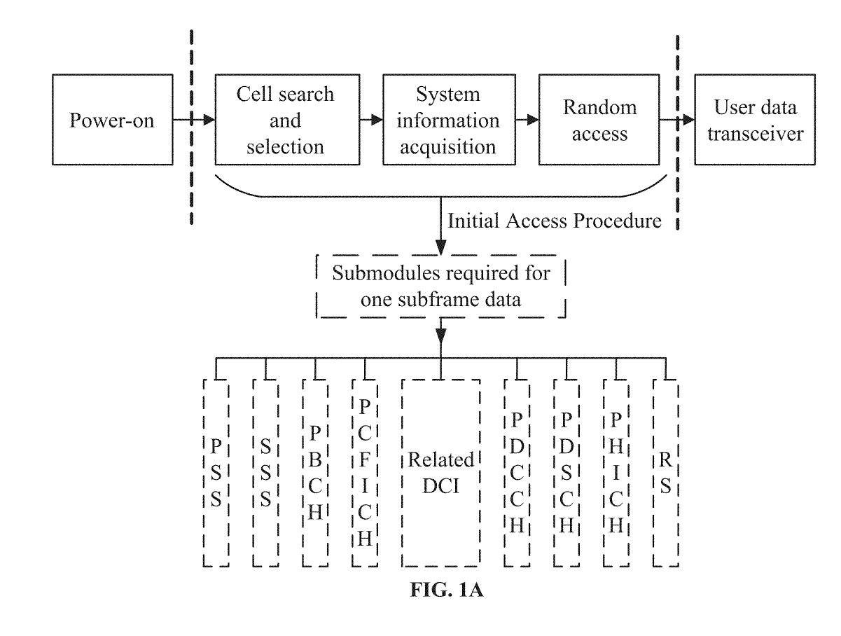

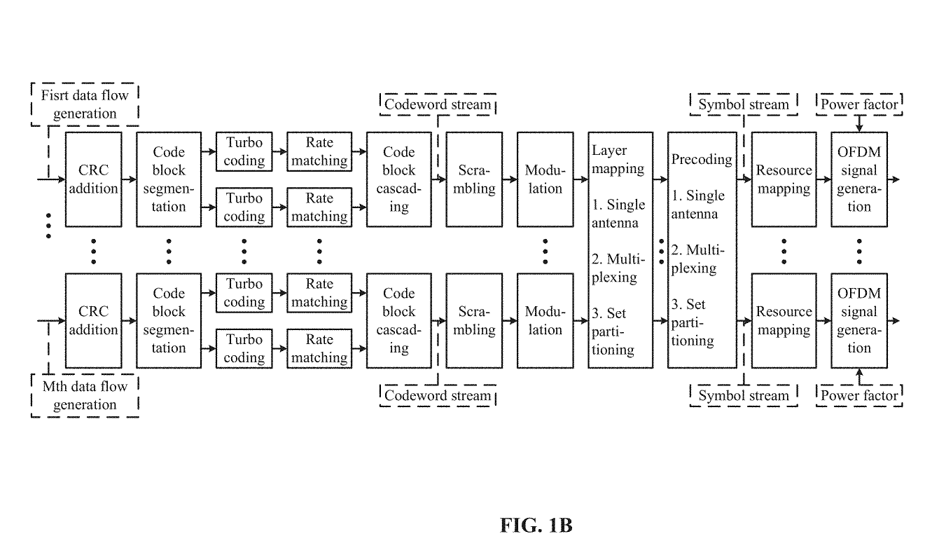

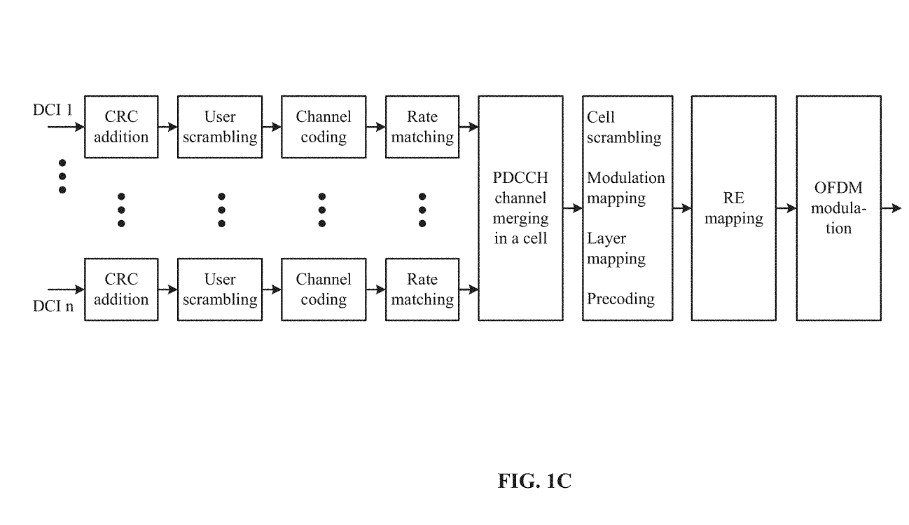

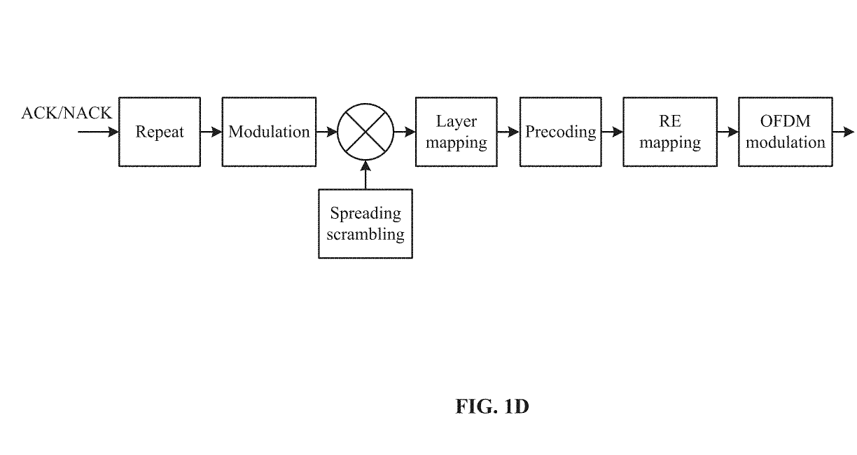

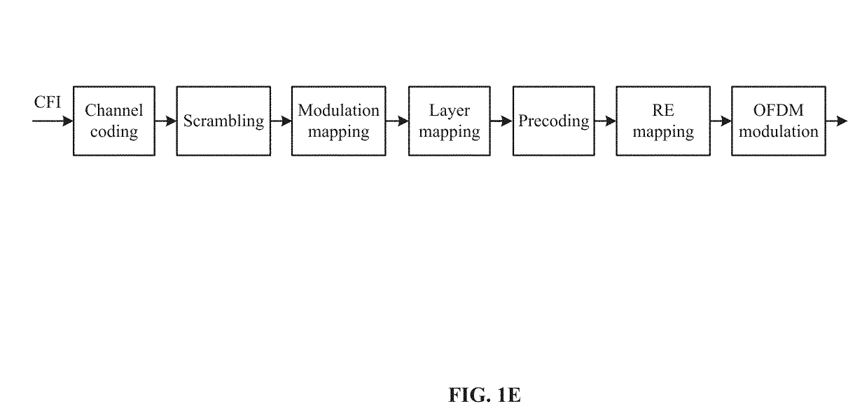

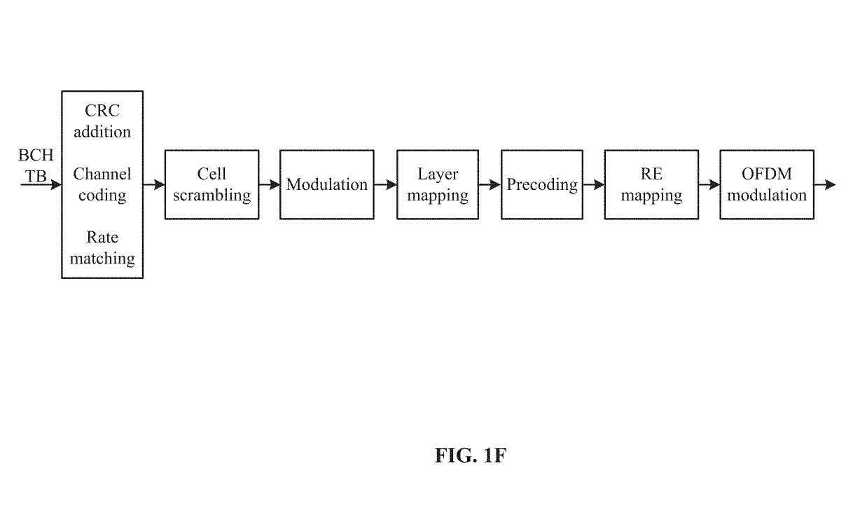

Referring to the block diagram of the LTE-A-based data source simulation platform shown in FIGS. 1A-1F. The data source simulation platform comprises a transmitting side and a receiving side. The transmitting side comprises a parameter initializing module, a parameter calculation module, and a subframe data module. The receiving side comprises a system function configuration module, a downlink initial synchronization module, an error control module, a time-frequency estimation module, and a data parsing module.

According to the sending information of the base station, the simulation parameters are constructed and a subframe structure is set to simulate a raw data block to be transmitted by the physical layer; the transport block size is determined by a modulation coding scheme and the number of physical resource block data.

According to the physical protocol table, the parameters are calculated to generate link parameters, which are mainly for configuration of resource blocks.

According to the downlink transmission link, the data simulation of each module of a subframe is accomplished and the generated data result is displayed; a transmitting end module comprises a synchronization signal, a reference signal, format control information, and generation of a channel module.

The synchronization signal module: the main task of the cell search involves a series of synchronization processes, including coarse time synchronization and frequency synchronization, and simultaneously acquiring physical layer cell ID; a primary synchronization signal and a secondary synchronization signal are included: the primary synchronization signal is used for cell intra-group detection, symbol timing alignment and frequency synchronization, while the secondary synchronization signal is used for cell group detection, frame timing alignment, and CP length detection. The 504 cell identifiers are unique. Physical layer cell identifiers are divided into 168 unique physical layer cell identifier groups, and each group contains three unique identifiers. In such group, each physical cell identity is part of the group, and there is only one physical layer identifier group.

The reference signal module: it is used for downlink channel quality measurement and downlink channel estimation, that is, coherent detection and demodulation at a UE end; the reference signal comprises a cell-specific reference signal, a UE-specific reference signal, and a channel state indication reference signal; the cell-specific reference signal is used for channel estimation and correlation demodulation of all downlink transmission technologies except for the codebook-based beamforming technology, and is configured as {0} or {0, 1} or {0, 1, 2, 3} of an antenna port simulation parameter for transmission; the UE-specific reference signal is dedicated to the demodulation of data, and only needs to be transmitted for a specific mobile station in a resource block in a data block it transmits, and does not need to be transmitted in the entire frequency band like an original cell-specific reference signal, and this reference signal supports single-antenna port transmission of a downlink shared channel, and is configured as port 5 or 7 or 8 or {7, 8, . . . , v+6}, where, v is the number of layers and its maximum is 8; the channel state indication reference signal is dedicated to channel estimation of LTE-A downlink transmission, and may be configured as an antenna port {15} or {15, 16} or {15, 16, 17, 18} or {15, 16, 17, 18, 19, 20, 21, 22}; a downlink reference signal is specifically divided into a first reference signal and a second reference signal; the first reference signal is located in a first OFDM symbol, which helps a downlink control signal to be demodulated as early as possible; in frequency domain, a reference signal is inserted every 6 subcarriers, and this number is the result of balancing between channel estimation performance and RS overhead, and this can not only obtain good channel estimation performance on a typical frequency-selective fading channel, but also can control RS at a lower level; the downlink reference signal is then designed to have some orthogonality to support multi-antenna parallel transmission.

The downlink control information module: it is used to enable a terminal to correctly decode DCI information, to process PDSCH data or PUSCH data; this information comprises such as resource block allocation information, modulation scheme MCS, HARQ-ID, and several related contents.

The channel module: the channel module is divided into five channels; for the simulation platform, regarding generation of the channels, the respective channels have many commonalities for generation of submodules; generation of a downlink shared channel is the most representative, so the shared channel module is one of the core modules of the simulation platform, and the carried service data is scheduled and framed according to a processing flow of the channel; other links can be similarly processed according to the functions of the respective submodules of the channel to obtain a complete channel module, and then subframe data are generated according to the obtained channel module, and results are loaded into the subframe.

The data source simulation platform comprises some functional modules at a receiving end and the modules at a transmitting end; a link decoding module is another core submodule of the transmitting platform and calculates accuracy of data loaded into a subframe according to demodulation, and generates a constellation, thus obtaining an intuitive simulation result.

To facilitate test verification and performance evaluation in research of LTE-A air-interface monitoring devices, the disclosure designs a data source simulation transmission platform. The design of this platform adopts the idea of modularization and is accomplished in matlab; each data to be framed is set as a submodule and a link function is abstracted into a math function.

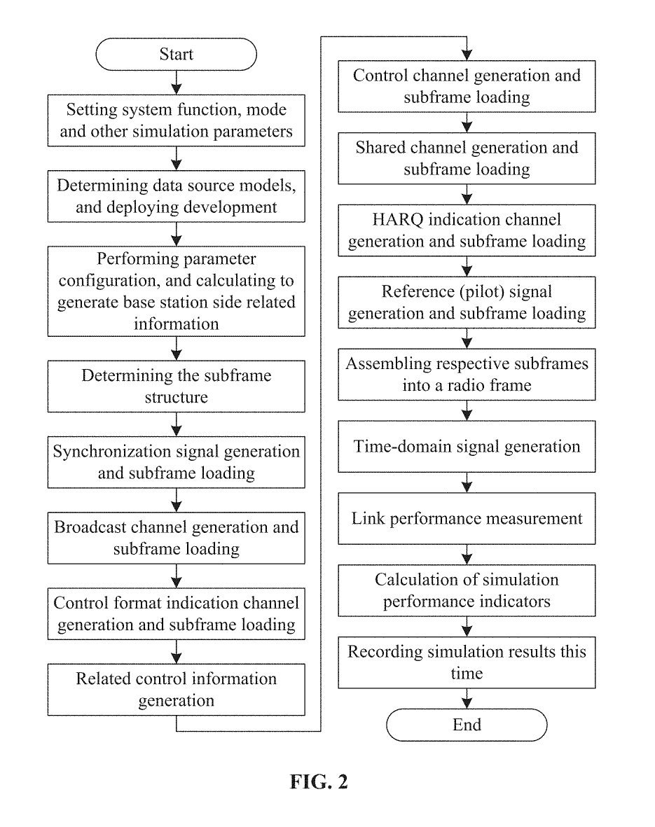

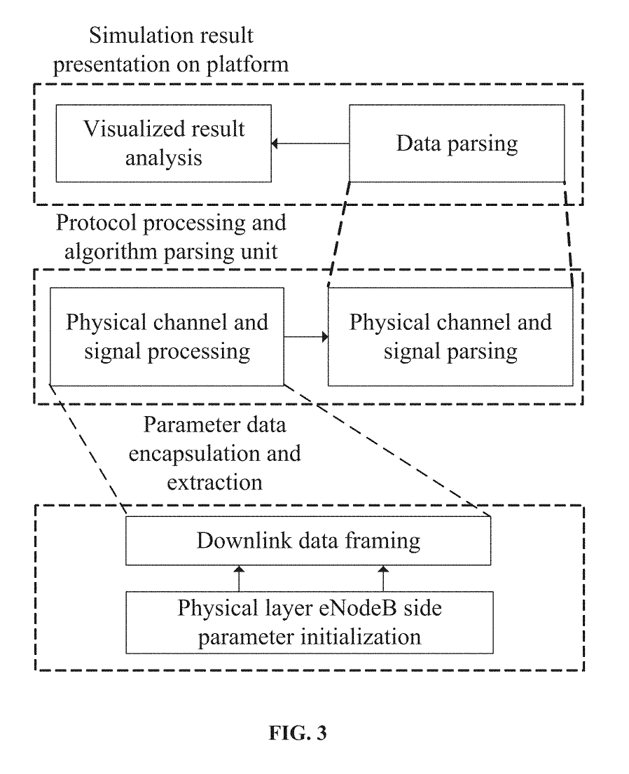

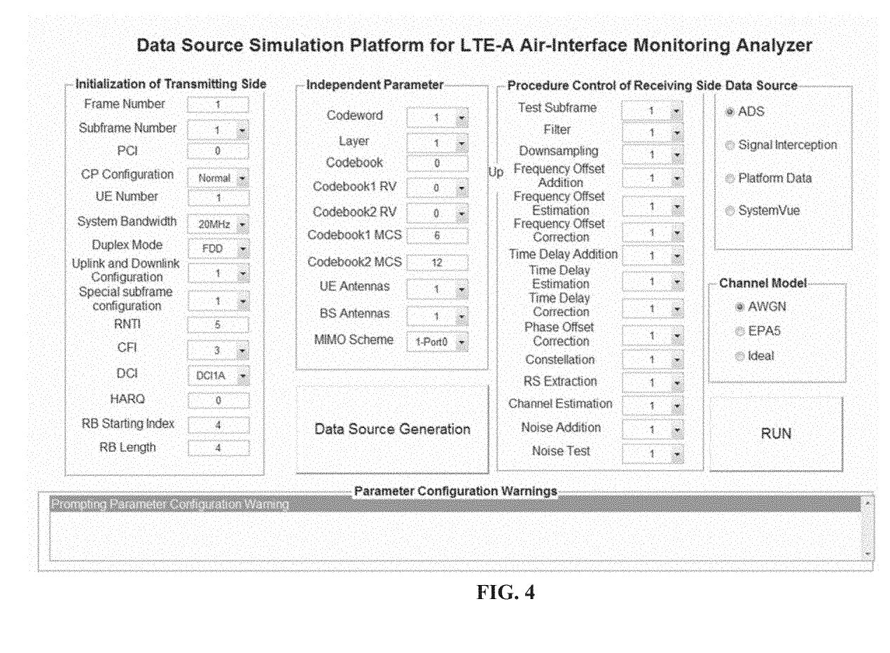

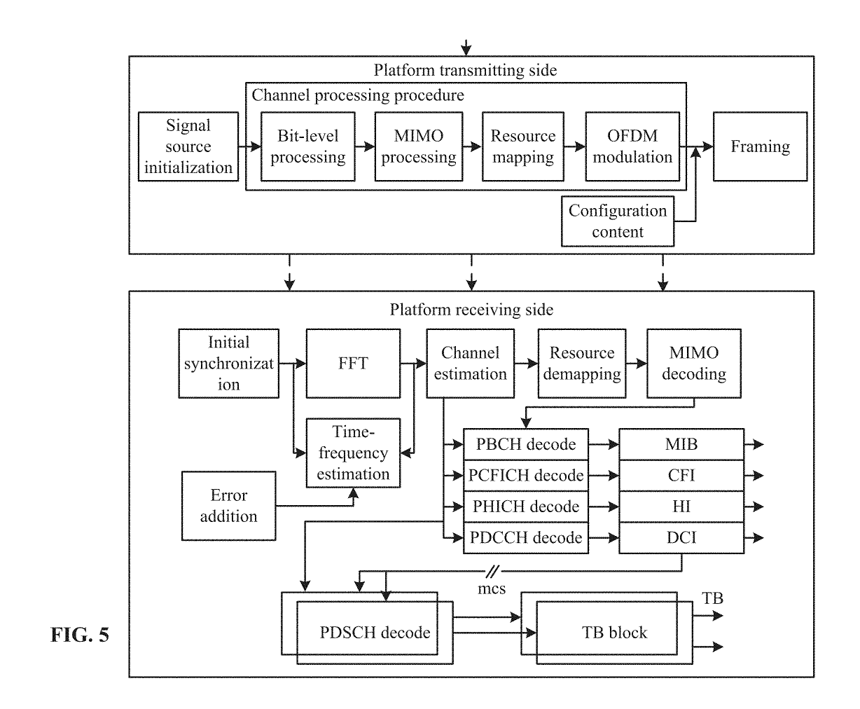

To implement the link-level simulation platform, the disclosure is developed in a process described below with reference to FIG. 2.

1) In the parameter initializing module, performing parameter configuration to simulate the base station parameters; the parameters comprise: transmission bandwidth, cell ID, system duplex mode, a modulation scheme, a cyclic prefix type, transmission mode, codeword, transmission scheme, number of antennas, number of mapping layers, control format information, redundancy version number, wireless network temporary identifier, number of physical resources, and so on.

2) Pre-calculating of parameters of the data source initialization module; specifically, under the premise of determining the control information format, select the size of a corresponding resource block group and the length of a bitmap, to accomplish a resource allocation process of a downlink shared channel.

3) With the parameters being independent of one another, after the initialization is completed, calculating the size of a downlink subframe resource array to obtain a frame structure.

4) Determining the frame structure and the subframe structure, and starting to enrich LTE-A downlink transmission data for each data generation module; the frame refers to a radio frame of an LTE-A air interface, with a length of 10 ms, each frame having 10 subframes and 20 time slots; each subframe has two time slots, each time slot being 0.5 ms; each time slot of LTE may have several physical resource blocks, and each physical resource block contains multiple subcarriers.

5) The synchronization signal is divided into a primary synchronization signal and a secondary synchronization signal, and as a first step of initial synchronization in the receiving side of the platform, first determining a multiplexing mode, that is, generating, according to a subframe number and a sequence formula of the primary and secondary synchronization signals, the positions of the two signals, then performing interpolation of resource fences.

6) The platform simulates the communication processing procedure of a broadcast channel, to generate main system information and broadcast channel information, and then framing via a resource mapping position specified by 3GPP protocol.

7) Different transmission modes correspond to different format control information; all relevant format control information is generated by a format control information configuration module, to meet the configuration requirements of a target data source of a monitoring instrument.

8) Using the format control information as input information of a control channel and transmitting parameters to a control channel generation module for channel processing, to obtain bit information, thereby obtaining resource mapping position information to repeat the framing.

9) According to the mapping of the transport block of the format control information, the physical control format indicator channel generation module performs the modulation from the bit-level processing to OFDM; the shared channel mainly carrying data functions as one of the core sub-modules to obtain the resource scheduling bit information via link processing, and by means of mapping physical signals such as reference signals, to control a control domain in the radio frame, which facilitates the resource allocation.

10) After all the channel and signal data are framed, converting data from frequency domain to time domain by means of an OFDM modulation; thereafter, on the transmitting side of the platform, selecting algorithms corresponding to respective modules for parsing and plotting, and comparing simulation results with data of the monitoring instrument.

It will be obvious to those skilled in the art that changes and modifications may be made, and therefore, the aim in the appended claims is to cover all such changes and modifications.

What is claimed is:

1. A data source simulation platform, comprising: a transmitting side and a receiving side; the transmitting side comprising:
a parameter initializing module being configured to construct simulation parameters, configure a subframe structure, and simulate a raw data block to be transmitted from a protocol data unit (PDU) packet of a media access control (MAC) layer to a physical layer;
a parameter calculation module being configured to calculate set simulation parameters; and
a subframe data module being configured to provide independent data for an air-interface monitoring device, the data being in a modular design and independently corresponding to each submodule;
the receiving side comprising:
a system function configuration module being configured to change a target data source for data comparison in a test phase;
a downlink initial synchronization module being configured to detect a downlink synchronization signal, the detection comprising frequency domain overlapping detection of a main synchronization signal and incoherent detection of an auxiliary synchronization signal;
an error control module being configured to add errors to a data and verify a corresponding algorithm;
a time-frequency estimation module being configured to estimate and correct a normalized time-frequency deviation before receiving demodulation data by fast Fourier transformation (FFT), and complete the synchronous tracking of input data before data parsing; and
a data parsing module being configured to parse the information carried by each channel and complete the processing opposite to channel links.

2. The platform of claim 1, wherein the subframe data module comprises:
a synchronization signal module being configured for cell intra-group detection, symbol timing alignment, frequency synchronization and cell group detection, frame timing alignment, and CP length detection;
a reference signal module being configured for downlink channel quality measurement and downlink channel estimation, coherent detection and demodulation at a UE end; the reference signal comprising a cell-specific reference signal, a UE-specific reference signal, and a channel state indication reference signal;
a downlink control information module being configured to enable a terminal to correctly decode DCI information to process PDSCH data or PUSCH data; the downlink control information comprising resource block allocation information, modulation scheme modulation and coding scheme (MCS), hybrid automatic repeat request-identity (HARQ-ID);
a channel generation module; and
a channel link module.

3. The platform of claim 2, wherein the channel generation module comprises:
a physical downlink broadcast channel module: being configured to carry broadcast information and transmit parameters comprising system bandwidth and frame number in a cell;
a physical downlink control channel (PDCCH) module: being configured to indicate the number of orthogonal frequency division multiplexing (OFDM) symbols used for transmitting PDCCH in one subframe, to notify a UE about the size of a control region corresponding to a downlink subframe, that is, the number of OFDM symbols occupied by the control region;
a physical downlink control channel module: being configured to carry scheduling and other control information;
a physical downlink shared channel module: being configured to transmit service data, and is a downlink channel that carries primary user data in LTE, and includes a system broadcast message and a paging message that are not transmitted in PBCH; and
a physical downlink hybrid automatic retransmission indication channel module: being configured to respond an ACK/NACK indication for data transmitted by an uplink shared channel.

4. The platform of claim 3, wherein the channel link module comprises:
a cyclic redundancy check calculation module: being configured for error detection;
a code block segmentation module: being configured to adapt to data size for channel coding;
a cyclic redundancy check secondary addition module: being configured to reduce retransmission delay for hybrid automatic repeat request at a receiving end, and save processing time;
a channel coding module: being configured to change degree of redundancy of transmitted information to adapt to actual physical layer capability;
a rate matching module: being configured to select a bit stream formed by the channel coding module, to form a different coding rate and match a physical resource that is actually used;
a code block cascading module: being configured to connect rate-matched outputs of all code blocks, thus constituting a codeword of a length;
a scrambling module: being configured to achieve randomization of data interference, to reduce neighboring-cell interference to some extent;
a modulation module: being configured to convert various digital baseband signals into modulated signals suitable for channel transmission;
a multiple-input multiple-output (MIMO) processing module: being configured to improve capacity and reliability of channels, and reduce bit error rate at the link level;
a resource mapping module: being configured to sequentially map data signals to corresponding resource elements of a subframe according to a certain rule; and
an orthogonal frequency division multiplexing (OFDM) modulation module: being configured to generate a complex time-domain OFDM signal for each antenna port.
